(19) United States
(12) Patent Application Publication
(10) Pub. No.: US 2005/0210243 A1
(43) Pub. Date: Sep. 22, 2005

(54) System and method for improving client response times using an integrated security and packet optimization framework

(76) Inventors: Paul Leslie Archard, Westbank (CA); John Edward Tavs, Palo Alto, CA (US)

Correspondence Address: PATRICK J S INOUYE P S, 810 3RD AVENUE, SUITE 258, SEATTLE, WA, 98104, US

(21) Appl. No.: 11/130,770

(22) Filed: May 17, 2005

Related U.S. Application Data
(62) Division of application No. 09/967,481, filed on Sep. 28, 2001.

(51) Int. Cl. H04L 9/00

(52) U.S. Cl. 713/160; 713/151

(57) ABSTRACT

A system and method for providing integrated secured and optimized packet messaging is described. A plurality of request packets staged in a packet queue from a requesting client and specifying content for retrieval from a destination server are categorized. The content is retrieved from the destination server. The retrieved content is optimized for at least one such request packet. The retrieved content is exchanged as secure content protected using a cipher negotiated with the requesting client for at least one such request packet.

### CROSS-REFERENCE TO RELATED APPLICATIONS

This patent application is a divisional of U.S. patent application Ser. No. 09/967,481, filed on Sep. 28, 2001, pending, the priority filing date of which is claimed and the disclosure of which is incorporated by reference.

### FIELD OF THE INVENTION

The present invention relates in general to packet messaging and, in particular, to a system and method for providing integrated secured and optimized packet messaging.

### BACKGROUND OF THE INVENTION

With the widespread adoption of the Internet by corporate, government and private individuals alike, internetworks presently offer an alternative and almost universally accessible means of electronic data exchange. The Internet is a specific form of an internetwork, or wide area network, which interconnect graphically distributed computer systems. Internetworks are often interfaced to intranetworks, or local area networks, which interconnect proximate computer systems located within, for instance, a single building or office.

Most current internetworks and intranetworks are based on the transmission control protocol/internet protocol (TCP/IP) suite, such as described in W. R. Stephens, “TCP/IP Illustrated,” Vol. 1, Ch. 1, Addison-Wesley (1994), the disclosure of which is incorporated by reference. Computer systems and network appliances employing the TCP/IP suite implement a network protocol stack that includes a hierarchically structured set of protocol layers. Each protocol layer performs a set of predefined functions as specified by the official TCP/IP standards set forth in applicable requests for comment (RFC).

The growth of internetworks, particularly those offering TCP/IP-compliant solutions, has attracted the attention of companies engaged in electronic business (e-business) and electronic commerce (e-commerce). In particular, a strong need exists to provide reliable and robust security to support the transacting of on-line e-business and e-commerce. Responsive to this need, the Secure Sockets Layer (SSL) and Transport Layer Security (TLS) protocols have evolved and are commonly found in nearly every commercial browser and server supporting Web-based transactions. The SSL protocol is described in A. O. Freier, “The SSL Protocol-Version 3.0,” http://www.netscape.com/eng/ssl3/, Netscape Comm. Corp., Mountain View, Calif. (November 1996), the disclosure of which is incorporated by reference. The SSL and TLS protocols are widely available to interoperate with most TCP/IP protocol stacks to provide seamless and relatively transparent secured data exchanges.

Both the SSL and TLS protocols require an initial handshake between a requesting client and a destination server prior to commencing secure data exchanges. During the handshake, cipher, authentication and key information are exchanged. Once completed, the handshake results in the creation of a secure “channel” between the server and client over which symmetrically encrypted and authenticated data fragments are exchanged. Secure communications are thereafter limited to the one-to-one connection between the requesting client and the specific destination server.

Unfortunately, SSL and TLS protocol implementations exact a high computation toll on those servers supporting secure transactions. Each secure transaction must first be preceded by the negotiation and creation of a secure “channel” through a multi-step cipher key exchange between a requesting client and destination server. Subsequently, each packet exchanged through the secure channel must be encrypted and decrypted at each end, both operations of which may require significant processing resources. Due in part to the increased processing load on the dedicated server, client response times for completing secure transactions are significantly longer than needed for non-secure content delivery.

The response times for both secure and non-secure data exchanges can be improved by augmenting an existing dedicated server or server farm with external network appliances for accelerating and optimizing content delivery and providing security to data transfers. Application acceleration network appliances, such as the AppCelera ICX product, sold by Packeteer, Inc., Cupertino, Calif., dynamically detect and track the speed of client connections and browser type and version. These types of devices operate at the application layer to provide dynamic content compression and content transformation and can cache optimized Web objects. Content is transformed into Web objects optimized for delivery at each particular client connection speed and for rendering on a specific browser and version.

Security network appliances, such as the AppCelera ISX product, sold by Packeteer, Inc., Cupertino, Calif., provide a dedicated device that receives and processes client requests for secure data exchange. These devices operate at the session layer between the application layer and the transport layer to transparently off-load the key generation and encryption/decryption operations from the destination servers. When combined, application acceleration and security network appliances can substantially improve overall client response times by relieving the servers of performance-degrading content optimization and security-related key exchange and encryption/decryption operations.

In the prior art, individual Web servers can provide session layer security. However, such session layer security can only be provided using a dedicated destination server, as SSL- and TLS-based secure connections are one-to-one and cannot be transacted over a farmed server environment. A dedicated secure connection increases server load and can significantly degrade client response times, particularly for a large number of users.

Similarly, security network appliances can also provide session layer security. Security credentials are exchanged between the network appliance and requesting client, and the secure channel is formed directly with the network appliance, rather than a dedicated destination server. However, the security network appliance cannot redirect communications received on a non-secure port. Since non-secure traffic passes through unaltered, the security network appliance cannot prioritize traffic flow or optimize content delivery.

Therefore, there is a need for an approach to providing integrated security and optimized content delivery of transient messages exchanged in a distributed computing environment. Preferably, such an approach would be capable of supporting a farmed server environment and could further provide integrated traffic prioritization based on security and throughput capabilities. As well, such an approach could preferably provide port redirection to transparently cause a requesting client to switch between secure and non-secure communication ports.

### SUMMARY OF THE INVENTION

The present invention provides a system and method for negotiating and transacting a secure connection and optimizing content delivery in an integrated manner. Incoming client requests are received, categorized and prioritized based on whether the request is for a secure or non-secure connection and whether the destination server has been assigned a higher processing priority. A handshake is negotiated for each secure and non-secure connection. Secure connection handshakes result in an exchange of cipher, authentication and key information. Subsequent data exchanges over the secure connection are authenticated, encrypted and decrypted based on the negotiated secure cipher and key parameters. Content is optimized at an object level using data compression, by transforming content into optimized Web objects and by staging such content into a local cache. Non-prioritized requests are passed directly to the destination server.

One embodiment is a system and method for providing integrated secured and optimized packet messaging. A plurality of request packets staged in a packet queue from a requesting client and specifying content for retrieval from a destination server are categorized. The content is retrieved from the destination server. The retrieved content is optimized for at least one such request packet. The retrieved content is exchanged as secure content protected using a cipher negotiated with the requesting client for at least one such request packet.

A further embodiment is a system and method for improving client response times using an integrated security and packet optimization framework. An application executes within an application layer and exchanges messaging packets with a peer application in accordance with an end-to-end application protocol. A security and packet optimization framework is provided and is communicatively interposed between the application and peer application. A transport module executes within a transport layer and provides reliable messaging packet exchange with a peer transport module in accordance with an end-to-end transport protocol. A secure server module executes within a security layer interposed between the application layer and the transport layer. Secure records containing the messaging packets are selectively exchanged with a peer secure server module in accordance with an end-to-end security protocol. An acceleration module executes within the application layer and selectively optimizes content embedded with the messaging packets.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a distributed computing environment, including a system for providing integrated secured and optimized packet messaging, in accordance with the present invention.

FIG. 2 is a block diagram showing a network protocol stack as used in the distributed computing environment of FIG. 1.

FIG. 3 is a block diagram showing prior art systems for providing secure packet messaging.

FIG. 4 is a functional block diagram showing the system for providing integrated secured and optimized packet messaging of FIG. 1.

FIG. 5 is a data structure diagram showing a server table used by the system of FIG. 4.

FIG. 6 is a block diagram showing the software modules of the system of FIG. 4.

FIG. 7 is a flow diagram showing a method for providing integrated secured and optimized packet messaging in accordance with the present invention.

FIG. 8 is a flow diagram showing the routine for processing a client connection request for use in the method of FIG. 7.

FIG. 9 is a flow diagram showing the routine for processing an incoming client packet for use in the method of FIG. 7.

FIG. 10 is a flow diagram showing the routine for processing a secure incoming client packet for use in the routine of FIG. 9.

FIG. 11 is a flow diagram showing the routine for processing a non-secure incoming client packet for use in the routine of FIG. 9.

FIG. 12 is a flow diagram showing the routine for processing a client request for use in the routines of FIGS. 10 and 11.

FIG. 13 is a flow diagram showing the routine for processing an outgoing server packet for use in the method of FIG. 7.

FIG. 14 is a flow diagram showing the routine for processing a secure outgoing server packet for use in the routine of FIG. 13.

FIG. 15 is a flow diagram showing the routine for processing a non-secure outgoing server packet for use in the routine of FIG. 13.

### DETAILED DESCRIPTION

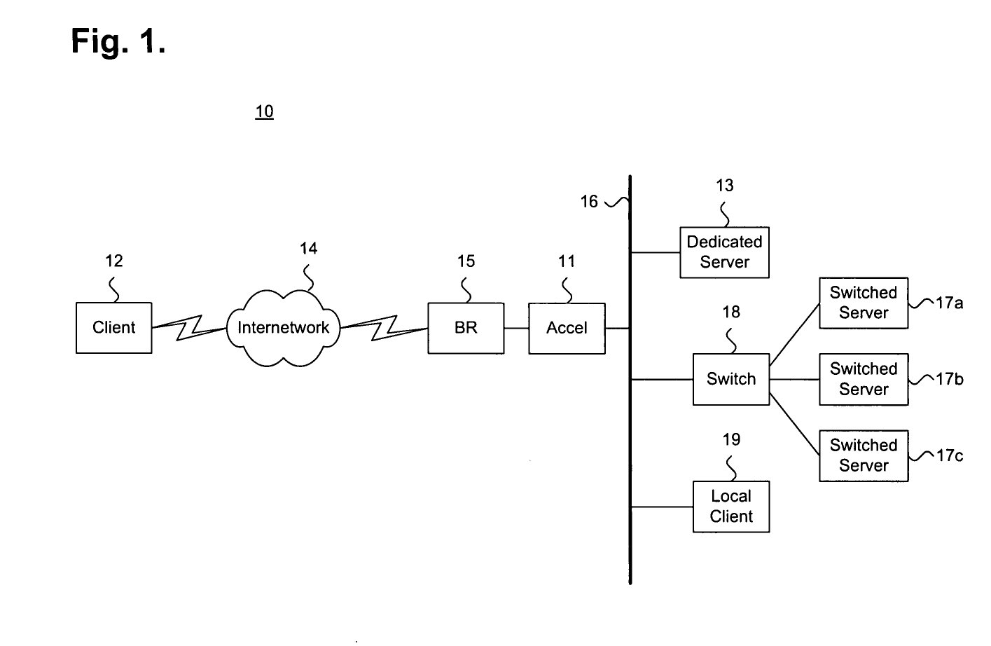

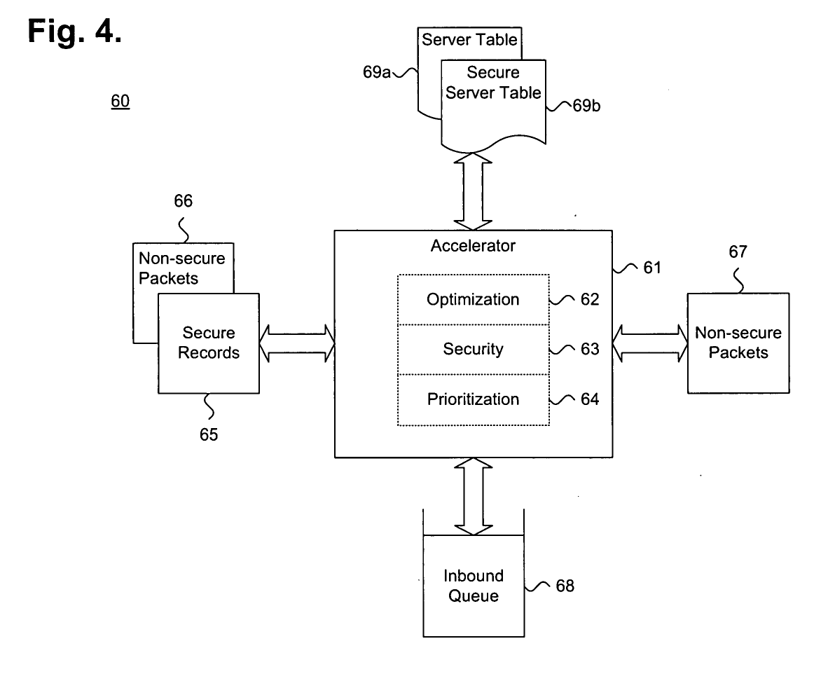

FIG. 1 is a block diagram showing a distributed computing environment 10, including a system for providing integrated secured and optimized packet messaging, in accordance with the present invention. By way of example, a client 12 remotely interfaces to a dedicated server 13 via an internetwork 14, such as the Internet. The dedicated server 13 is itself interconnected to an intranetwork 16 shared by a farm of switched servers 17a-c via a switch 18, and a local client 19. The intranetwork 16 interfaces to the internetwork 14 through a border router (BR) 15. An accelerator (accel) 11 is communicatively interfaced between the border router 15 and the intranetwork 16 to provide content acceleration and optimization and security to requesting clients 12, as further described below beginning with reference to FIG. 4. Other network configurations, topologies and arrangements of clients and servers are possible, as would be recognized by one skilled in the art.

The client 12, as well as the local client 19, sends requests for secure and non-secure content, including Web-based content using the Hypertext Transport Protocol (HTTP). Each request is received by either the dedicated server 13 or one of the switched servers 17a-c for processing. The responding destination server 13, 17a-c coupled sends the requested content back to the client 12. The accelerator 11 intercepts the content and compresses and optimizes individual objects embedded therein. As well, the accelerator 11 includes a cache in which previously-requested content can be staged as transient objects. Subsequent requests from remote clients for cached objects will be processed by the accelerator 11, thereby relieving the load from the servers 13, 17a-c. In addition, requests for a secured connection, such as via an SSL or TLS session, are negotiated and transacted directly with the accelerator 11.

The individual computer systems, including clients 12, 19 and servers 13, 17a-c, are general purpose, programmed digital computing devices consisting of a central processing unit (CPU), random access memory (RAM), non-volatile secondary storage, such as a hard drive or CD ROM drive, network interfaces, and peripheral devices, including user interfacing means, such as a keyboard and display. Program code, including software programs and data, are loaded into the RAM for execution and processing by the CPU and results are generated for display, output, transmittal, or storage.

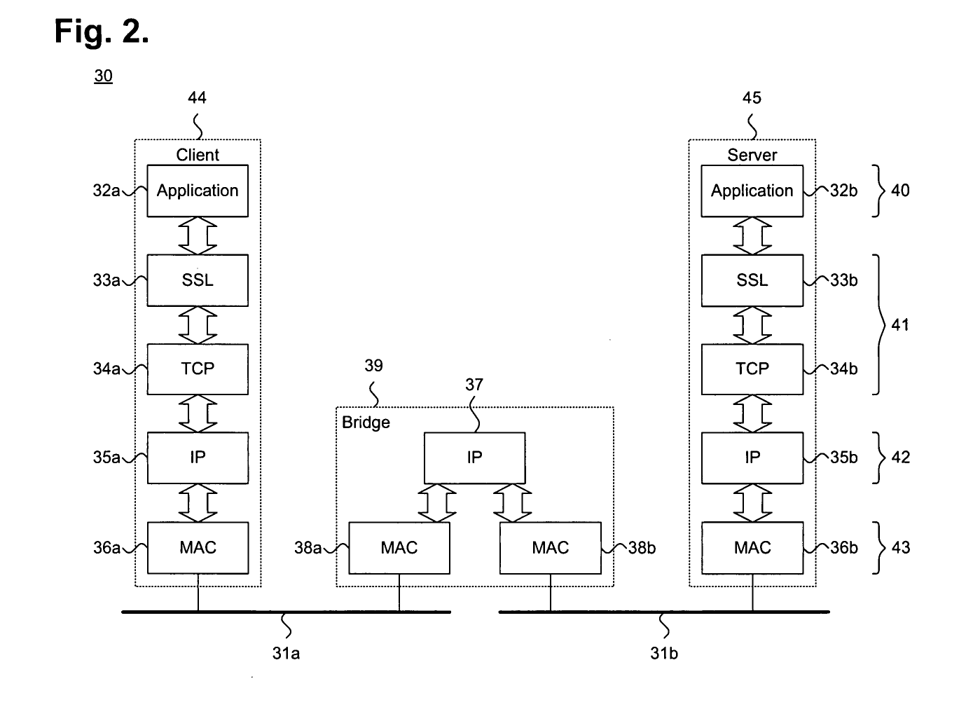

FIG. 2 is a block diagram showing network protocol stack 30 as used in the distributed computing environment 10 of FIG. 1. By way of example, an internetwork consisting of two separate internetworks 31a and 31b are connected through a bridge 39 or similar routing device for connecting networks. The protocol stack 30 includes four layers: application 40, transport 41, network 42, and link 43, each in compliance with the TCP/IP protocol, such as described in W. R. Stephens, “TCP/IP Illustrated,” Vol. 1, Ch. 1, Addison-Wesley (1994), the disclosure of which is incorporated by reference. A client 44 and a server 45 are interconnected to a respective internetwork 31a, 31b. Both the client 44 and server 45 implement a full TCP/IP protocol stack consisting of an application 32a, 32b executing in the application layer 40; a transmission control protocol (TCP) module 34a, 34b executing in the transport layer 41; an Internet protocol (IP) module 35a, 35b executing in the network layer 42; and a media access controller 36a, 36b executing in the link layer 43, respectively. Each of the modules executing in their respective protocol layer 40-43 logically communicate with their peer module in a corresponding protocol stack. Thus, packets generated by an application 32a in the protocol stack of the client 44 are exchanged with the corresponding application 32b in the protocol stack of the server 45.

The application and transport layers 40 and 41 implement end-to-end protocols operating between network endpoints, that is, the client 44 and the server 45. The modules in the network and link layers 42 and 43 implement point-to-point protocols operating between each individual “hop” along a path in a network between two network endpoints. Accordingly, intermediate network bridging devices, such as the bridge 39, need only implement partial network protocol stacks that implement modules in the network and link layers 42 and 43, such as an IP module 37 and a pair of MACs 38a, 38b in the link layer 43.

In addition to the foregoing standard TCP/IP protocol layer modules, the transport layer 41 further includes a pair of secure socket layer (SSL) modules 33a, 33b for exchanging secured records between the two client/servers 44, 45. Each SSL module 33a, 33b implements the SSL Handshake Protocol and SSL Record Protocol, such as described in E. Rescorla, “SSL and TLS-Designing and Building Secure Systems,” Ch. 1-3, Addison-Wesley (2001), the disclosure of which is incorporated by reference. Technically, the SSL modules operate at a session layer, as specified in the ISO/OSI open systems interconnect model. However, TCP/IP lacks a specific session layer specification and the SSL protocol is grouped into the transport layer as an additional end-to-end protocol.

When an application 32a executing on a requesting client 44 requires a secure communication channel, the SSL module 33a initiates a secure handshake with a peer SSL module 33b executing on a destination server 45. During the initial handshake, the requesting client begins the secure channel request by sending the server 45 a list of site-supported cipher algorithms and a random number used as input to a key generation process. In reply, the SSL module 33b on the destination server 45 chooses a cipher algorithm and sends back a certificate, including a public key for the server. The certificate includes the identity of the server for authentication and a random number also used as part of the key generation process. Upon receipt, the client 44 verifies the server certificate and extracts the public key of the server. The client 45 generates a random secret string, which is encrypted using the public key of the server and is sent to the server 45. The client 44 and server 45 independently compute a symmetric encryption key and message authentication code (MAC). In the described embodiment, RC2, RC4 and plaintext encryptions schemes are used, with RC4 being preferred. The client 44 sends the MAC of all handshake messages to the server 45 and the server 45 sends a MAC of all handshake messages back to the client 44.

Upon completion of the foregoing steps, a secure communications channel is formed and packets are thereafter exchanged between the client 44 and server 45 as encrypted data using the negotiated encryption key. For outgoing packets, each SSL module 33a, 33b receives packets from the corresponding application 32a, 32b and breaks up the data stream into a series of fragments that are independently encrypted and transmitted. A MAC is computed over each fragment and the fragment and MAC are together encrypted using the encryption key to form an encrypted payload. A record header is attached to the encrypted payload and the complete record is exchanged with the peer SSL module.

For incoming packets, each SSL module 33a, 33b receives records from the corresponding TCP module 34a, 34b and decrypts the encrypted payload. Each decrypted fragment is authenticated using the MAC and the original application-layer packet is reassembled. The packet is then forwarded to the corresponding application 32a, 32b.

Upon completion of secure data exchange, the client 44 sends a finished handshake message to the server 45, which in return acknowledges with a termination handshake. Secure communication is then complete.

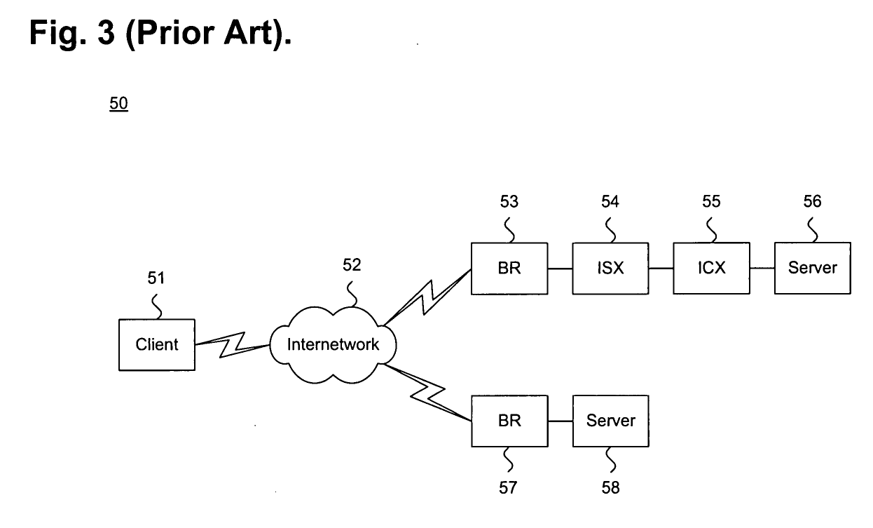

FIG. 3 is a block diagram showing a prior art system 50 for providing secured packet messaging. A remote client 51 interfaces to servers 56, 58 via an internetwork 52. A border router 53, 57 interfaces each of the servers 56, 58, respectively, to the internetwork 52. An Internet Security Accelerator (ISX) 54 and an Internet Content Accelerator (ICX) 55 are communicatively interfaced to the server 56 in serial fashion. The Internet Content Accelerator 55 optimizes content delivery at an object level through compression, content transformation and object caching. The Internet Security Accelerator 54 executes an SSL handshake sequence with a requesting client 51 and subsequently encrypts messages exchanged between the server 56 and requesting client 51. The server 56 is able to maximize content delivery by delegating the optimization of content delivery and security to the Internet Content Accelerator 55 and Internet Security Accelerator 54, respectively.

In contrast, the server 58 handles both content optimization and security as part of the services provided. Accordingly the performance of the server 58 suffers by the additional workload imposed to optimize content delivery and provide security handshaking, encryption and decryption.

In both of the prior art Internet security solutions, content optimization and security are provided through additional network appliances or increased capabilities intrinsic to a server. In the first approach, requests for secure transactions are first intercepted by the Internet Security Accelerator 54 or are passed through to the Internet Content Accelerator 55 and server 56. Requests for secure content are received on a specific port, conventionally, port 443, and non-secure requests are received on a separate port, conventionally, port 80. Since non-secure requests are passed-through without alteration or inspection, the Internet Security Accelerator 54 is unable to dynamically request the redirection of a request for a non-secure connection to an alternative secure port. In addition, the Internet Security Accelerator 54 cannot prioritize a plurality of connections based on queuing loads. Similarly, the server 58 provides all content functions, including content delivery, optimization and security. As a dedicated system, however, the server 58 cannot delegate server functions over a farm of interconnected servers. Neither prior art approach is satisfactory, as client response times are compromised by inherent device limitations.

FIG. 4 is a functional block diagram showing the system for providing integrated secured and optimized packet messaging 60 of FIG. 1. The system comprises an accelerator 61, operating in three logical phases comprising optimization 62, security 63 and prioritization 64. Non-secure packet 66 and 67 are exchanged between requesting client (not shown) and the destination server (not shown). An inbound queue 68 is used by the accelerator 61 to stage incoming requests from clients. The delivered content from each destination server is received as a non-secure packet 66. The accelerator 61 maintains a set of tables, server table 69a and secure server table 69b, in which are maintained the IP addresses, port numbers and relative priorities of all servers and secure servers, respectively.

The optimization phase 62 optimizes Internet content through compression, transformation and caching. The speed of each client connection and client Web browser version is dynamically detected and tracked. The optimization phase 62 examines each outgoing non-secure packet 67 and optimizes individual objects embedded therein, prior to encryption, if applicable. The optimization phase 62 operates on an object level to optimize individual Web objects, such as graphics, to accommodate client connection speeds and the rendering speed for the particular Web browser used on each client. As well, the optimization phase 62 interfaces to a cache for transiently staging compressed and transformed content.

The security phase 63 provides SSL layer security to requesting clients. A handshake sequence in compliance with the SSL Handshake Protocol is first performed upon the requesting of a new secure connection 64. Thereafter, encrypted records are transmitted in compliance with the SSL Record Protocol.

The prioritization phase 64 intercepts incoming client packets and prioritizes the processing and delivery of content based on the nature of the connection, that is, secure or non-secure, and whether the destination server has been a higher processing priority. The relative priorities of each connection are indicated in the server table 69a and secure server table 69b.

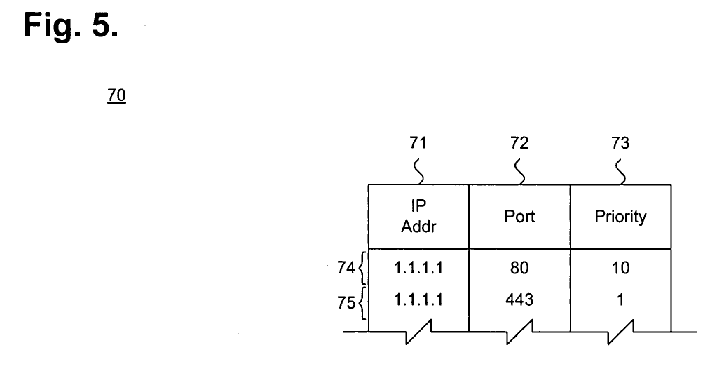

FIG. 5 is a data structure diagram showing a server table 70 used by the system of FIG. 4. The server table 70 includes three columns for storing in IP address 71, port number 72 and relative priority 73 of each server. Note the same format is used in the secure server table 69b (shown in FIG. 4). The server table 70 includes a plurality of records 74, 75 each listing those destination servers supported by the accelerator 61. The server table 70 includes records 74 for a non-secure server and records 75 for secure servers. Note the relative priority 73 for the secure server is higher than that of the non-secure server.

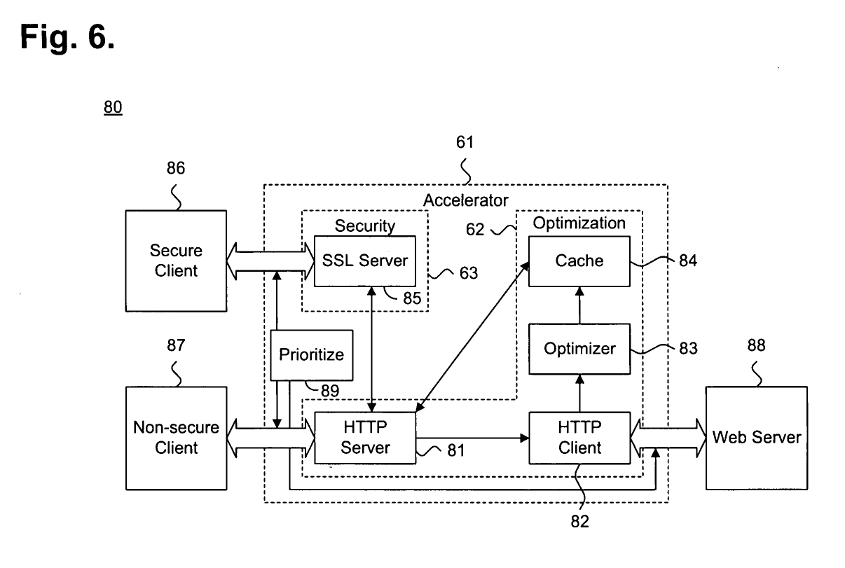

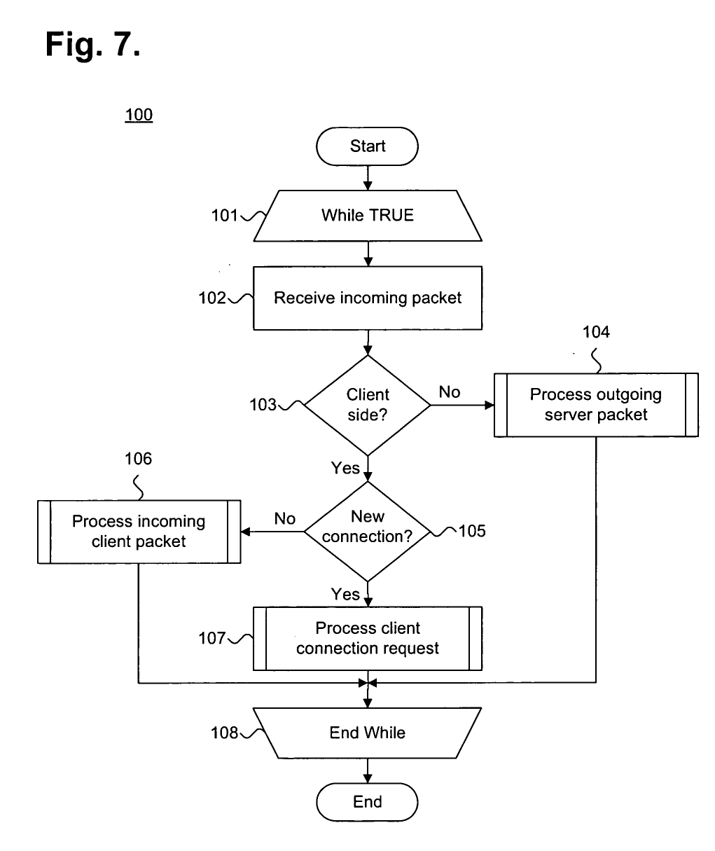

FIG. 6 is a block diagram showing the software modules of the system 61 of FIG. 4. Each module is a computer program, procedure or module written as source code in a conventional programming language, such as the C++ programming language, and is presented for execution by the CPU as object or byte code, as is known in the art. The various implementations of the source code and object and byte codes can be held on a computer-readable storage medium or embodied on a transmission medium in a carrier wave. The accelerator system 61 operates in accordance with a sequence of process steps, as further described below with reference to FIG. 7.

The accelerator 61 implements the optimization 62, security 63 and prioritization phases (shown in FIG. 4). The optimization phase 62 is implemented in four logical modules: HTTP server 81, HTTP client 82, optimizer 83, and cache 84. The HTTP server 81 is an internal Web server that receives requests for non-secure content from non-secure clients 87. The HTTP server 81 receives requests through conventional well known port numbers 80, as is known in the art. Other types of non-HTTP servers are also feasible, as would be recognized by one skilled in the art.

The HTTP server 81 attempts to deliver the requested non-secure content by first checking the cache 84 for a transiently staged copy of the requested (and optimized) content. If found, the cached content is delivered back to the non-secure client 87. Otherwise, the HTTP server 81 forwards the request to an internal HTTP client 82 which simulates the non-secure client 87 by forwarding the request for non-secure content to the Web server 88.

In response, the Web server 88 returns the requested content which the internal HTTP client 82 forwards to an internal optimizer 83 for compression, optimization and transient storage in the cache 84. The optimized content is then forwarded to an HTTP server 81 which in turn delivers the content to the non-secure client 87.

In addition, both secure and non-secure client connection requests may be initially received from a non-secure port, such as port 80. The HTTP server 81 will request a client to resend a secure client connection request to a secure port, such as port 443, thereby providing dynamic port redirection.

The security phase 63 is implemented in an SSL server 85 that negotiates and exchanges secured content. The SSL server 85 receives requests through conventional well-known IP port number 443, as is known in the art. The SSL server 63 executes a handshake in compliance with the SSL Handshake protocol and exchanges encrypted records in compliance with SSL Record Protocol.

The prioritization phase 64 is implemented in a prioritize module 89 that intercepts incoming traffic and prioritizes the delivery of content based on the nature of the connection, that is, secure or non-secure, and whether the destination server has been a higher processing priority. In the described embodiment, the prioritize module 89 favors content being sent over a secure versus non-secure connection. In addition, individual servers can be arbitrarily assigned a higher processing priority over other servers. For example, a server delivering image data might be assigned a higher priority than a server delivering text data. When possible, connections serving higher priority servers are favored over other servers. The prioritize module 89 includes a bypass route to skip processing by the accelerator 61 altogether.

The prioritize module 89 monitors the size of the inbound queue 76 (shown in FIG. 4) to determine whether the request can be processed by the accelerator 61 or must be passed through to the Web server 88 unchanged. A full inbound queue 68 will automatically result in a request packet being forwarded directly to the Web server 88. As well, a secure request or request being delivered to a Web server 88 assigned a higher processing priority will generally be preferred and processed by the accelerator 61 over other requests, as resources allow, or will alternatively be passed through to the Web server 88, but logged as having been of potential interest.

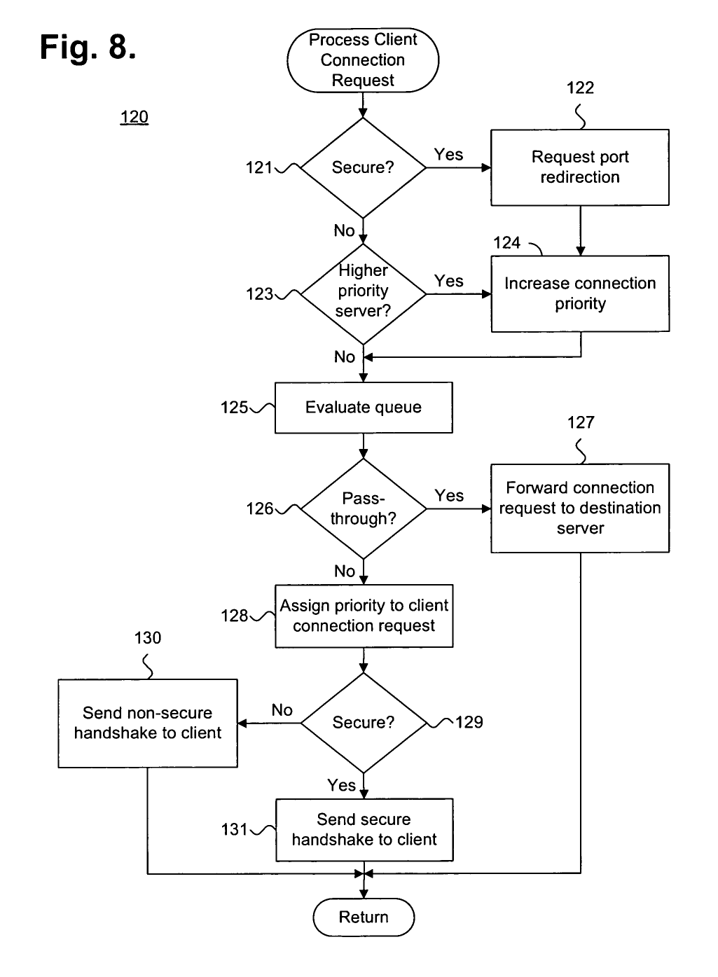

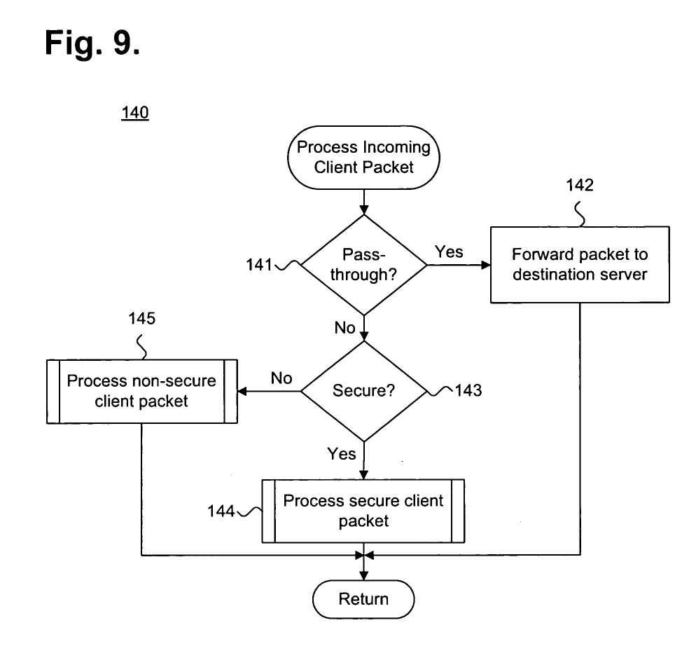

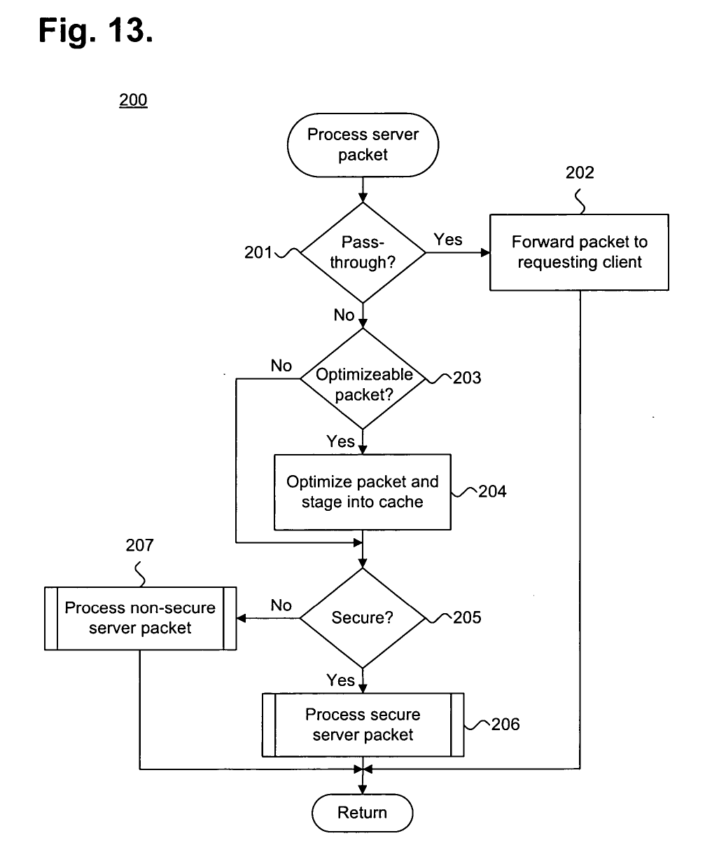

FIG. 7 is a flow diagram showing a method for providing integrated secured and optimized packet messaging 100 in accordance with the present invention. The method continuously processes packet traffic in an iterative processing loop (blocks 101-108) as follows. During each iteration (block 101), an incoming packet is received (block 102) and classified. If the packet is not received from the client side (block 103), that is, is a non-secure packet 67 (shown in FIG. 4) received from a Web server 88 (shown in FIG. 6), the packet is processed as an outgoing server packet 67 (block 104), as further described below with reference to FIG. 13. Otherwise, if the packet is received from the client side (block 103), that is, the packet is a secure record 65 or non-secure packet 66 (shown in FIG. 4) received from a secure client 86 or non-secure client 87, respectively (shown in FIG. 6), the packet is further examined as originating from a new connection (block 105). If the packet is from an existing connection (block 105), the client packet is processed (block 106) as further described below with reference to FIG. 9. Otherwise, if the client side packet is requesting a new connection (block 106), the client connection request is processed (block 107), as further described below with reference to FIG. 8. Iterative processing continues (block 108) until the routine is terminated.

FIG. 8 is a flow diagram showing the routine for processing a client connection 120 request for use in the method of FIG. 7. The purpose of this routine is to prioritize and classify a client connection request based on request type and inbound queue status.

Thus, both secure and non-secure client connection requests may be received from a non-secure port, such as port 80. If the client connection request is for a secure connection (block 121), a redirection to a secure port, such as port 443, is requested (block 122) by asking the client to resend the secure client connection request to a secure port. The priority of the client connection request is then increased (block 124). Otherwise, if the client connection request is for a non-secure connection (block 121) but specifies a destination server assigned a higher processing priority (block 123), the connection priority for the client connection request is also increased (block 124). Otherwise, the inbound queue 76 (shown in FIG. 4) is evaluated (block 125) for available load.

If the connection cannot be processed, the request packet must be passed through (block 126), the client connection request is forwarded to the destination server 88 (shown in FIG. 6) (block 127) and the routine returns. Otherwise, if the connection is not being passed through (block 126), a priority is assigned to the client connection request (block 128) if the client connection request is for a secure connection (block 129), a secure handshake is sent to the client (block 131) and the routine completes. Otherwise, a non-secure handshake is sent to the requesting client (block 120), and the routine returns.

FIG. 9 is a flow diagram showing the routine for processing an incoming client packet 140 for use in the method of FIG. 7. The purpose of this routine is to either pass through non-processable incoming client request packets or to categorize optimizable request packets accordingly.

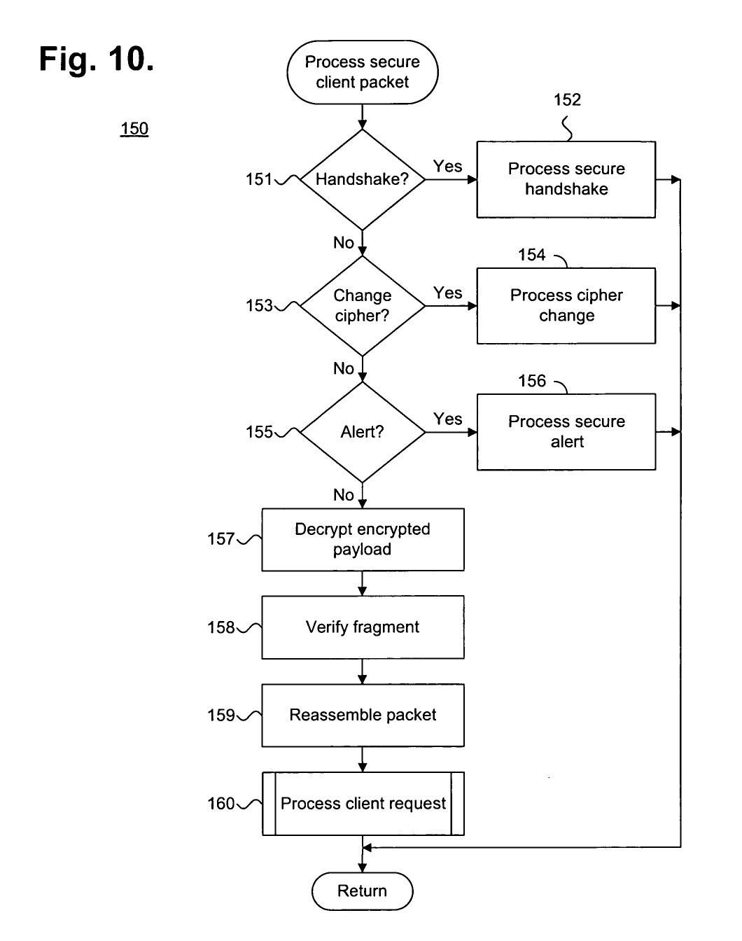

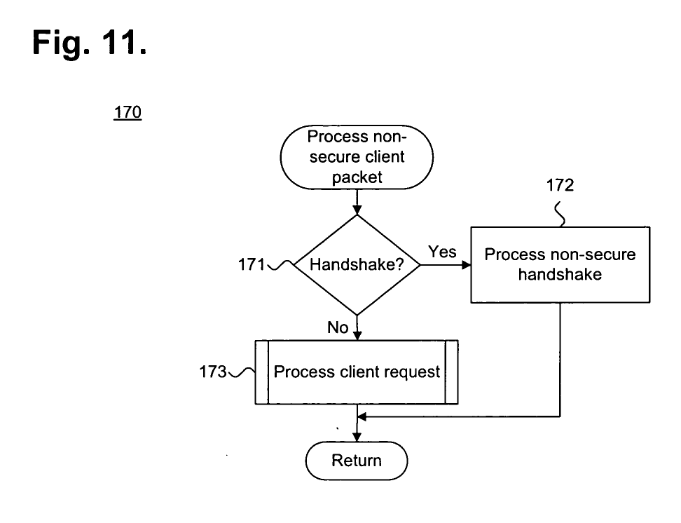

Thus, if the packet cannot be processed and is being passed through (block 141), the packet is forwarded to the destination server 88 (shown in FIG. 6) (block 142), and the routine returns. Otherwise, if the packet is not being passed through (block 141) and is for a secure connection (block 143), the secure packet is processed (block 124), as further described below with reference to FIG. 10. If the packet is for non-secure content (block 143), the non-secure client packet is processed (block 145), as further described below with reference to FIG. 11. The routine then returns.

FIG. 10 is a flow diagram showing the routine for processing a secure incoming client packet 150 for use in the routine of FIG. 9. The purpose of this routine is to process an incoming secure client packet based on packet type.

The SSL protocol supports four types of packets: handshake, change cipher specification, alert and application data. Encrypted records containing packet fragments are exchanged as application data. Handshake packets contain handshake messages as unencrypted data preparatory to initiating a secure connection and a finished message to terminate a secured connection and prevent replay attacks. An alert message is used to signal various types of errors such as handshake, decryption or authentication errors. Finally, change cipher specification messages are used to change encryption and authentication methodologies and parameters.

Thus, if the secure client packet is a handshake packet (block 151), the secure handshake packet is processed (block 152) to either negotiate an initial secure connection or to terminate a completed secure connection. If the secure client packet is a change cipher specification packet (block 153), the cipher change is processed (block 154) to put into force a negotiated new set of keys for use in encrypting and decrypting packets. If the secure client packet is an alert packet (block 155), the secure alert is processed (block 156) to signal an error condition.

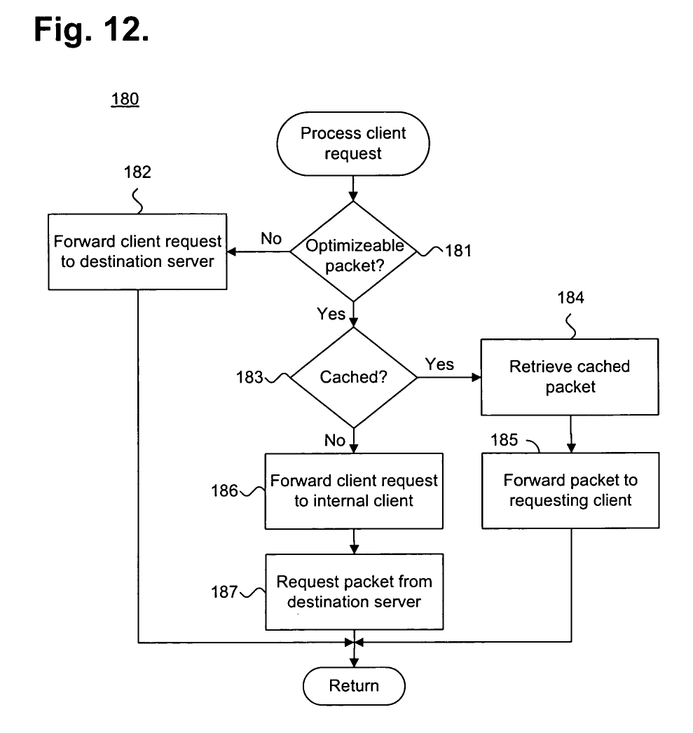

Otherwise, the secure client packet is application data. The encrypted payload is decrypted (block 157) and the decrypted fragment verified (block 158). The original packet is reassembled (block 159) and the client request processed (block 160), as further described below with reference to FIG. 12. The routine then returns.

FIG. 11 is a flow diagram showing the routine for processing a non-secure incoming client packet 170 for use in the routine of FIG. 9. The purpose of this routine is to categorize an incoming non-secure client packet and process the packet accordingly.

Thus, if the non-secure client packet is a handshake packet (block 171), such as a TCP three-way handshake, the non-secure handshake is processed (block 172). Otherwise, the non-secure client packet is application data and the client request is processed (block 173), as further described below with reference to FIG. 12. The routine then returns.

FIG. 12 is a flow diagram showing the routine for processing a client request 180 for use in the routines of FIGS. 10 and 11. The purpose of this routine is to either forward an incoming client request packet to the destination server or to process the client request as an optimizable packet.

Thus, if the client request is a non-optimizable packet (block 181), the client request is forwarded to the destination server 88 (shown in FIG. 6) (block 182), after which the routine returns.

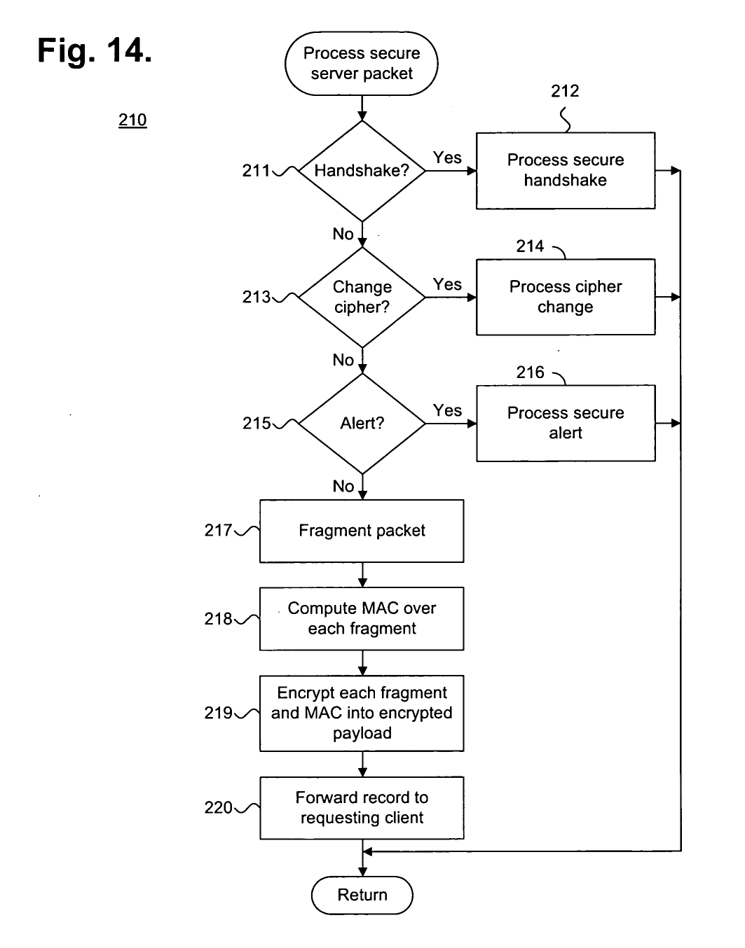

Otherwise, if the client request is an optmizable packet (block 181) and is present in the cache 84 (shown in FIG. 6) (block 183), the packet is retrieved from the cache (block 184) and forwarded to the requesting client 86, 87 (shown in FIG. 6). Note a packet being forwarded to a secure client 86 must first be encrypted, as further described below with reference to FIG. 14. The routine then returns.

If the optimizable packet is not locally cached (block 183), the client request is forwarded to the internal HTTP client 82 (shown in FIG. 6) (block 186) and the packet is requested from the Web server 88 (block 187), after which the routine returns.

FIG. 13 is a flow diagram showing the routine for processing an outgoing server packet 200 for use in the method of FIG. 7. The purpose of this routine is to optimize objects embedded within an outgoing server packet, if possible, and to categorize the server packet based on the type of outgoing connection, that is, secure or non-secure.

All outgoing packets received from a server are non-secure packets 67 (shown in FIG. 4) and any required security is processed by the accelerator 61. If the server packet is being passed through (block 201), the packet is simply forwarded to the requesting client 86, 87 (shown in FIG. 6) (block 202), after which the routine returns.

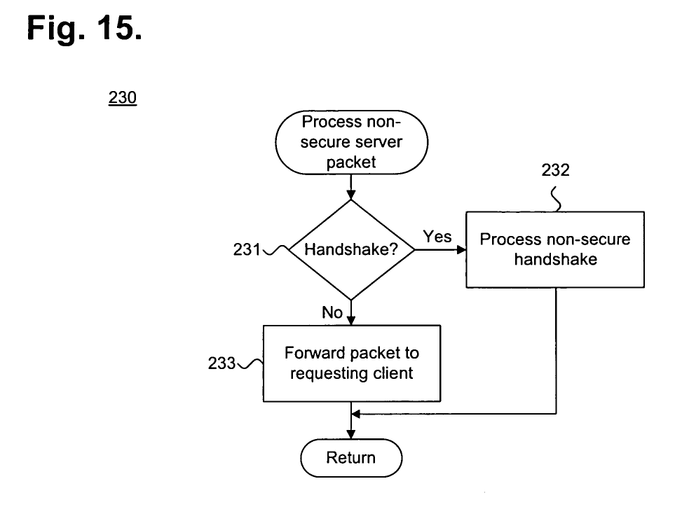

Otherwise, if the server packet is not being passed through (block 201), and is optimizable (block 203), the packet is optimized by the optimizer 83 and staged into the cache 84 (block 204). If the server packet is on a secure connection (block 205), the secure server packet is processed (block 206) as further described below with reference to FIG. 14. Otherwise, the non-secure server packet is processed (block 207), as further described below with reference to FIG. 15. The routine then returns.

FIG. 14 is a flow diagram showing the routine for processing a secure outgoing server packet 210 for use in the routine of FIG. 13. The purpose of this routine is to categorize an outgoing secure server packet and process the packet accordingly.

Thus, if the secure client packet is a handshake packet (block 211), the secure handshake packet is processed (block 212) to either negotiate an initial secure connection or to terminate a completed secure connection. If the secure client packet is a change cipher specification packet (block 213), the cipher change is processed (block 214) to put into force a negotiated new set of keys for use in encrypting and decrypting packets. If the secure client packet is an alert packet (block 215), the secure alert is processed (block 216) to signal an error condition.

If the packet is application data, each packet is first fragmented (block 217) and a MAC computed over each individual fragment (block 218). Each fragment and MAC is then encrypted into an encrypted payload (block 219). A record header is attached and the resulting encrypted record is forwarded to the requesting secure client 86 (shown in FIG. 6) (block 220), after which the routine returns.

FIG. 15 is a flow diagram showing the routine for processing a non-secure outgoing server packet 230 for use in the routine of FIG. 13. The purpose of this routine is to categorize an outgoing non-secure server packet and process the packet accordingly.

Thus, if the non-secure client packet is a handshake packet (block 231), such as a TCP three-way handshake, the non-secure handshake is processed (block 232). Otherwise, the non-secure client packet is application data and the packet is forwarded to the requesting non-secure client 78 (shown in FIG. 6) (block 233), after which the routine returns.

While the invention has been particularly shown and described as referenced to the embodiments thereof, those skilled in the art will understand that the foregoing and other changes in form and detail may be made therein without departing from the spirit and scope of the invention.

1. A system for improving client response times using an integrated security and packet optimization framework, comprising:
an application executing within an application layer and exchanging messaging packets with a peer application in accordance with an end-to-end application protocol;
a security and packet optimization framework providing communicatively interposed between the application and peer application, comprising:
a transport module executing within a transport layer and providing reliable messaging packet exchange with a peer transport module in accordance with an end-to-end transport protocol;
a secure server module executing within a security layer interposed between the application layer and the transport layer and selectively exchanging secure records containing the messaging packets with a peer secure server module in accordance with an end-to-end security protocol; and
an acceleration module executing within the application layer and selectively optimizing content embedded with the messaging packets.

2. A system according to claim 1, further comprising:
a prioritize module prioritizing the exchanging of the messaging packets based on characteristics pertaining to the peer application and connection channel thereto.

3. A system according to claim 2, wherein each such messaging packet requires at least one of secure record exchange and content delivery from a higher priority server are assigned a higher priority.

4. A system according to claim 1, further comprising:
a redirection submodule requesting redirection of a messaging packet request to an alternate port supporting at least one of secure and non-secure message exchange.

5. A system according to claim 1, further comprising:
an optimize module compressing content embedded within at least one such messaging packet and transforming content embedded within at least one such messaging packet.

6. A system according to claim 1, further comprising:
a cache staging content embedded within at least one such messaging packet.

7. A system according to claim 1, further comprising:
a secure handshake module negotiating cipher, authentication and key information between the secure server module and the peer secure server module prior to exchanging the secure records.

8. A system according to claim 7, wherein the secure server module is authenticated to the peer secure server module.

9. A system according to claim 7, wherein the peer secure server module is authenticated to the secure server module.

10. A system according to claim 7, wherein the cipher, authentication and key information negotiation is performed in accordance with the SSL Handshake Protocol.

11. A system according to claim 1, further comprising:
a secure record module encrypting each outgoing such secure records and decrypting each incoming such secure records using a symmetric cipher.

12. A system according to claim 11, wherein each outgoing such messaging packet is fragmented and a message authentication code is generated over each outgoing such fragment; and each incoming such fragment is authenticated using the message authentication code and each incoming such message packet is reassembled.

13. A system according to claim 11, wherein the encryption and decryption is performed in accordance with the SSL Record Protocol.

14. A method for improving client response times using an integrated security and packet optimization framework, comprising:
executing an application within an application layer and exchanging messaging packets with a peer application in accordance with an end-to-end application protocol;
providing a security and packet optimization framework communicatively interposed between the application and peer application, comprising:
executing a transport module within a transport layer and providing reliable messaging packet exchange with a peer transport module in accordance with an end-to-end transport protocol;
executing a secure server module within a security layer interposed between the application layer and the transport layer and selectively exchanging secure records containing the messaging packets with a peer secure server module in accordance with an end-to-end security protocol; and
executing an acceleration module within the application layer and selectively optimizing content embedded with the messaging packets.

15. A method according to claim 14, further comprising:
prioritizing the exchanging of the messaging packets based on characteristics pertaining to the peer application and connection channel thereto.

16. A method according to claim 15, further comprising:
assigning a higher priority to each such messaging packet requiring at least one of secure record exchange and content delivery from a higher priority server.

17. A method according to claim 14, further comprising:
requesting redirection of a messaging packet request to an alternate port supporting at least one of secure and non-secure message exchange.

18. A method according to claim 14, further comprising:
compressing content embedded within at least one such messaging packet; and
transforming content embedded within at least one such messaging packet.

19. A method according to claim 14, further comprising:
staging content embedded within at least one such messaging packet.

20. A method according to claim 14, further comprising:
negotiating cipher, authentication and key information between the secure server module and the peer secure server module prior to exchanging the secure records.

21. A method according to claim 20, further comprising:
authenticating the secure server module to the peer secure server module.

22. A method according to claim 20, further comprising:
authenticating the peer secure server module to the secure server module.

23. A method according to claim 20, further comprising:
performing the cipher, authentication and key information negotiation in accordance with the SSL Handshake Protocol.

24. A method according to claim 14, further comprising:
encrypting each outgoing such secure records and decrypting each incoming such secure records using a symmetric cipher.

25. A method according to claim 24, further comprising:
fragmenting each outgoing such messaging packet and generating a message authentication code over each outgoing such fragment; and
authenticating each incoming such fragment using the message authentication code and reassembling each incoming such message packet.

26. A method according to claim 11, further comprising:
performing the encryption and decryption in accordance with the SSL Record Protocol.

27. A computer-readable storage medium holding code for performing the method according to claim 14.
